(19) United States
(12) Patent Application Publication
(10) Pub. No.: US 2011/0217606 A1
(43) Pub. Date: Sep. 8, 2011

(54) HYDROGEN GENERATION DEVICE AND FUEL CELL

(75) Inventors: Yueh-Chang Wu, Hsinchu County (TW); Cheng Wang, Hsinchu County (TW); Po-Kuei Chou, Hsinchu County (TW)

(73) Assignee: YOUNG GREEN ENERGY CO., HSINCHU COUNTY (TW)

(21) Appl. No.: 13/014,723

(22) Filed: Jan. 27, 2011

(30) Foreign Application Priority Data
Mar. 5, 2010 (CN) 201010130007.7

(51) Int. Cl. H01M 8/06

(52) U.S. Cl. 429/421

(57) ABSTRACT

A hydrogen generation device adapted to a fuel cell is provided. The hydrogen generation device includes a containing tank and a buffer layer. The buffer layer is disposed in the containing tank and divides the containing tank into a first containing space and a second containing space. The first containing space is capable of containing a liquid reactant. The second containing space is capable of containing a first solid fuel. The liquid reactant is capable of entering the second containing space through the buffer layer and reacts with the first solid fuel to generate hydrogen.

### CROSS-REFERENCE TO RELATED APPLICATION

This application claims the priority benefit of China application serial no. 201010130007.7, filed on Mar. 5, 2010. The entirety of the above-mentioned patent application is hereby incorporated by reference herein and made a part of this specification.

### BACKGROUND OF THE INVENTION

1. Field of the Invention

The invention generally relates to a hydrogen generation device and a fuel cell having the hydrogen generation device, and more particularly, to a hydrogen generation device using a solid fuel and a fuel cell having the hydrogen generation device.

2. Description of Related Art

A fuel cell is an electricity generation apparatus that directly converts chemical energy into electrical energy. Compared to the conventional electricity generation techniques, a fuel cell offers lower pollution, lower noise, higher energy density, and higher energy conversion efficiency and therefore the fuel cell is a very promising clean energy source. Fuel cells may be applied to portable electronic products, home electricity generation systems, transportation vehicles, military equipments, the space industry, and small-scale electricity generation systems, etc.

Different fuel cells have different applications according to the operating principles and operating environments thereof. Proton exchange membrane fuel cells (PEMFCs) and direct methanol fuel cells (DMFC cells) are mostly applied to portable power sources. Both PEMFC and DMFC are low temperature fuel cells using a proton exchange membrane for conducting protons. According to the operating principle of such a fuel cell, oxidation of hydrogen is carried out in the anode catalyst layer to produce hydrogen ions H⁺and electrons e⁻(the operating principle of PEMFC), or water oxidation of methanol is carried out in the anode catalyst layer to produce hydrogen ions H⁺, carbon dioxide (CO₂), and electrons e⁻(the operating principle of DMFC), wherein the hydrogen ions H⁺are conducted by the proton exchange membrane to the cathode, while the electrons e⁻are first transmitted by an external circuit to the load before they are conducted to the cathode. Herein a redox reaction between the oxygen supplied to the cathode and the hydrogen ions H⁺and electrons e⁻is carried out in the cathode catalyst layer and water is produced. The hydrogen supplied to the anode may be obtained through a solid NaBH₄ hydrogen storage technique, wherein water is added into solid NaBH₄, and the two react with each other to produce hydrogen.

If a large amount of water is directly reacted with solid NaBH₄, the reaction will be too energetic to generate hydrogen stably. Thus, additional valves have to be disposed in the system for controlling the release of hydrogen, and this will increase the complexity, structural strength, and cost of the system. In addition, a filling (for example, silicon) may be added into the solid NaBH₄ to slow down the reaction. However, this will reduce the weight percent of hydrogen generated in the reaction.

### SUMMARY OF THE INVENTION

Accordingly, the invention is directed to a hydrogen generation device, wherein a solid fuel slowly reacts with water to release hydrogen stably.

The invention is directed to a fuel cell, wherein a solid fuel in a hydrogen generation device of the fuel cell slowly reacts with water to release hydrogen stably.

Additional aspects and advantages of the invention may be further understood from the description that follows.

According to an embodiment of the invention, a hydrogen generation device adapted to a fuel cell is provided. The hydrogen generation device includes a containing tank and a buffer layer. The buffer layer is disposed in the containing tank and divides the containing tank into a first containing space and a second containing space. The first containing space is capable of containing a liquid reactant. The second containing space is capable of containing a first solid fuel. The liquid reactant is capable of entering the second containing space through the buffer layer and reacts with the first solid fuel to generate hydrogen.

According to an embodiment of the invention, a fuel cell including a hydrogen generation device, a fuel cell stack, and a guiding structure is provided. The hydrogen generation device includes a containing tank and a buffer layer. The buffer layer is disposed in the containing tank and divides the containing tank into a first containing space and a second containing space. The first containing space is capable of containing a liquid reactant. The second containing space is capable of containing a first solid fuel. The liquid reactant is capable of entering the second containing space through the buffer layer and reacting with the first solid fuel to generate hydrogen. The guiding structure is connected between the hydrogen generation device and the fuel cell stack and is capable of guiding the hydrogen generated in the reaction between the first solid fuel and the liquid reactant to the fuel cell stack.

As described above, in an embodiment of the invention, a buffer layer is disposed in a containing tank and is located between a liquid reactant and a solid fuel. Thus, the liquid reactant may be continuously conducted to the solid fuel through the buffer layer, so that the solid fuel and the liquid reactant may slowly react with each other to release hydrogen stably. Thereby, the weight percent of the hydrogen generated in the reaction is increased, and both the volume and the cost of the entire system are reduced.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a diagram of a hydrogen generation device according to an embodiment of the invention.

FIG. 1B is a diagram illustrating a buffer layer in FIG. 1A being turned into a porous structure layer.

FIG. 1C is a diagram of the hydrogen generation device in FIG. 1A after a liquid reactant reacts with a solid fuel.

FIG. 2 is a diagram of a hydrogen generation device according to another embodiment of the invention.

FIG. 3 is a diagram of a hydrogen generation device according to another embodiment of the invention.

FIG. 4 is a diagram of a hydrogen generation device according to another embodiment of the invention.

FIG. 5 is a diagram of a hydrogen generation device according to another embodiment of the invention.

FIG. 6 is a diagram of a hydrogen generation device according to another embodiment of the invention.

FIG. 7A is a diagram of a hydrogen generation device according to another embodiment of the invention.

FIG. 7B is a diagram illustrating a reaction of a liquid reactant and a solid fuel in the hydrogen generation device in FIG. 7A.

FIG. 8 is a diagram illustrating the disposition of a capillary structure in the hydrogen generation device in FIG. 7A.

FIG. 9 is a diagram illustrating the hydrogen generation device in FIG. 1A being applied in a fuel cell.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

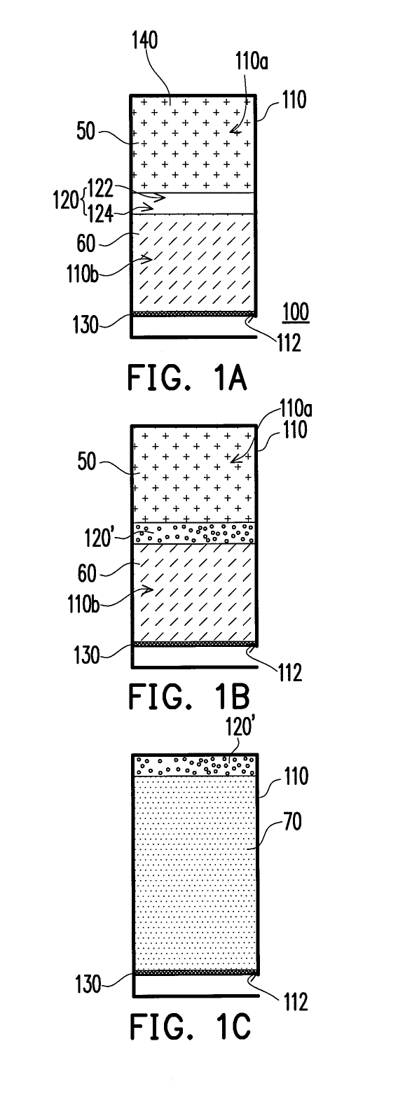

FIG. 1A is a diagram of a hydrogen generation device according to an embodiment of the invention. FIG. 1B is a diagram illustrating a buffer layer in FIG. 1A being turned into a porous structure layer. FIG. 1C is a diagram of the hydrogen generation device in FIG. 1A after a liquid reactant reacts with a solid fuel. Referring to FIG. 1A, the hydrogen generation device 100 in the present embodiment is adaptable to a fuel cell for supplying hydrogen required by the reaction at the anode side of the fuel cell. The hydrogen generation device 100 includes a containing tank 110 and a buffer layer 120. The buffer layer 120 is disposed in the containing tank 110 and divides the containing tank 110 into a first containing space 110a and a second containing space 110b.

The first containing space 110a is capable of containing a liquid reactant 50. The second containing space 110b is capable of containing a solid fuel 60. In the embodiment, the buffer layer 120 includes a filling material 122 and a solid fuel 124, wherein the filling material 122 and the solid fuel 124 may respectively be silicon and NaBH₄ powder. The liquid reactant 50 in the first containing space 110a reacts with the solid fuel 124 to generate hydrogen, such that the buffer layer 120 is turned into a porous structure layer 120′, as shown in FIG. 1B. Then, the unreacted liquid reactant 50 is continuously conducted to the solid fuel 60 through the porous structure layer 120′ so that the solid fuel 60 may slowly react with the liquid reactant 50 to release hydrogen stably.

In the embodiment, the liquid reactant 50 and the solid fuel 60 (124) may respectively be liquid water and NaBH₄ powder. However, the invention is not limited thereto, and the liquid reactant 50 and the solid fuel 60 (124) may also be other substances capable of generating hydrogen. Besides, catalysts may also be added to the solid fuel 60 (124) to accelerate the reaction between the liquid reactant 50 and the solid fuel 60 (124).

The entire structure after the reaction is illustrated in FIG. 1 C. The water solution 70 generated in the reaction between the solid fuel 60 and the liquid reactant 50 fills up the containing tank 110 and pushes the porous structure layer 120′ to the top of the containing tank 110. If the liquid reactant 50 and the solid fuel 60 are respectively liquid water and NaBH₄ powder, the water solution 70 may be NaBO₂•H₂O or

NaBO₂•4H₂O.

In the embodiment, the containing tank 110 has an opening 112 connected with the second containing space 110b, and the hydrogen generation device 100 further includes a liquid impermeable and gas permeable membrane 130 covering the opening 112. Thus, the hydrogen generated in the reaction between the solid fuel 60 and the liquid reactant 50 may be exhausted from the containing tank 110 through the liquid impermeable and gas permeable membrane 130, and the water solution 70 generated in the reaction between the solid fuel 60 and the liquid reactant 50 is blocked by the liquid impermeable and gas permeable membrane 130 and will not leak out. Besides, the hydrogen generation device 100 may further include a water absorbing structure 140 disposed in the first containing space 110a. The water absorbing structure 140 absorbs the liquid reactant 50 to form water-based adhesive for securing the liquid reactant 50 in the first containing space 110a. However, the invention is not limited thereto, and in other embodiments, the water absorbing structure 140 may be omitted and the liquid reactant 50 may be directly contained in the first containing space 110a.

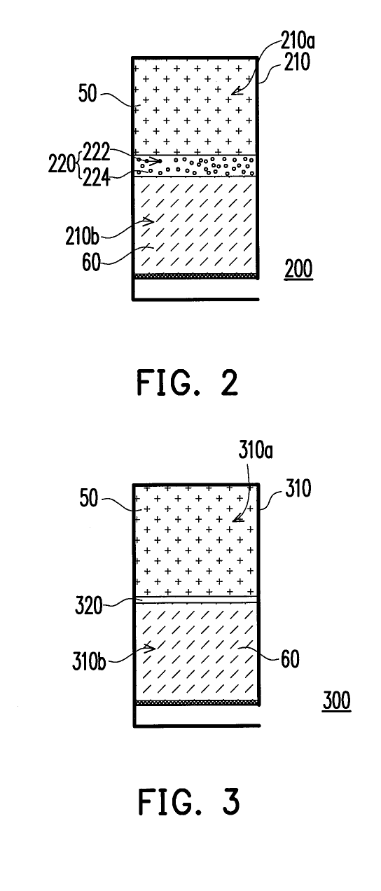

FIG. 2 is a diagram of a hydrogen generation device according to another embodiment of the invention. Referring to FIG. 2, in the hydrogen generation device 200 of the embodiment, a porous structure layer 220 is directly disposed in the containing tank 210 as a buffer layer. The liquid reactant 50 in the first containing space 210a is constantly conducted to the solid fuel 60 in the second containing space 210b through the porous structure layer 220, so that the solid fuel 60 slowly reacts with the liquid reactant 50 to release hydrogen stably. Besides, a solid fuel 224 may be filled in the pores of the porous structure layer 220 and reacted with the liquid reactant 50 to generate hydrogen. A filling material 222 may be further filled in the porous structure layer 220, as shown in FIG. 1A.

FIG. 3 is a diagram of a hydrogen generation device according to another embodiment of the invention. Referring to FIG. 3, in the hydrogen generation device 300 of the embodiment, a liquid permeable and gas impermeable membrane 320 is disposed in the containing tank 310 as a buffer layer. The liquid reactant 50 in the first containing space 310a is constantly conducted to the solid fuel 60 in the second containing space 310b through the liquid permeable and gas impermeable membrane 320, so that the solid fuel 60 slowly reacts with the liquid reactant 50 to release hydrogen stably.

The liquid permeable and gas impermeable membrane 320 in the embodiment may be a proton exchange membrane. To be specific, the liquid permeable and gas impermeable membrane 320 may be a polystyrene sulfonic acid (PSSA) membrane, a perfluorosulfonic acid membrane, a tetrafluoroethylene (TFE) porous membrane, a TFE porous and perfluorosulfonic acid composite membrane, a non-fluorinated proton exchange membrane, a polyethersulfone, or a partially-fluorinated proton exchange membrane. Besides, the liquid permeable and gas impermeable membrane 320 may also be made of poly(ether-ether-ketone) (PEEK), polyimide, or polyamide-imide (PAI).

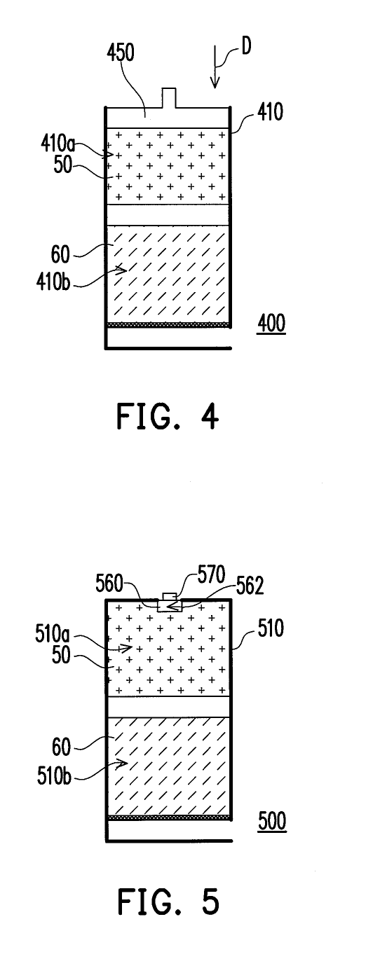

FIG. 4 is a diagram of a hydrogen generation device according to another embodiment of the invention. Referring to FIG. 4, the hydrogen generation device 400 in the embodiment further includes a piston 450. The piston 450 is movably disposed at the first containing space 410a of the containing tank 410, and which is capable of moving along the direction D to increase the pressure in the first containing space 410a, so as to force the liquid reactant 50 to move downwards and react with the solid fuel 60 in the second containing space 410b.

FIG. 5 is a diagram of a hydrogen generation device according to another embodiment of the invention. Referring to FIG. 5, the hydrogen generation device 500 in the embodiment includes a capsule 560 and a resistor 570 connected to the capsule 560. The capsule 560 is disposed in the first containing space 510a of the containing tank 510, and a solid fuel 562 is disposed in the capsule 560. When the resistor 570 is heated and accordingly the capsule 560 is burnt, the solid fuel 562 enters the first containing space 510a and reacts with the liquid reactant 50 to generate gas, so that the pressure in the first containing space 510a is increased and the liquid reactant 50 is forced downwards to react with the solid fuel 60 in the second containing space 510b. The solid fuel 562 is not limited to any particular type in the invention, and which may be any suitable substance that may react with the liquid reactant 50 to generate hydrogen, carbon dioxide or other gas.

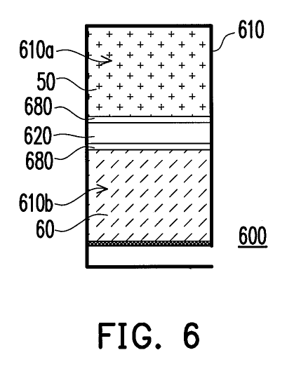

FIG. 6 is a diagram of a hydrogen generation device according to another embodiment of the invention. Referring to FIG. 6, the hydrogen generation device 600 in the embodiment further includes microporous layers 680 (two are illustrated in FIG. 6). The microporous layers 680 are stacked on the buffer layer 620 and are respectively located in the first containing space 610a and the second containing space 610b of the containing tank 610. The microporous layers 680 further slow down the falling speed of the liquid reactant 50 so that the solid fuel 60 may react with the liquid reactant 50 at a slower speed and accordingly hydrogen may be released more stably. The number of the microporous layers 680 is not limited in the invention. In another embodiment, the microporous layers 680 may be disposed above or below the buffer layer 620. The microporous layers 680 may be formed by coating carbon particles (powder) with binder on a piece of carbon fiber sheet or carbon paper.

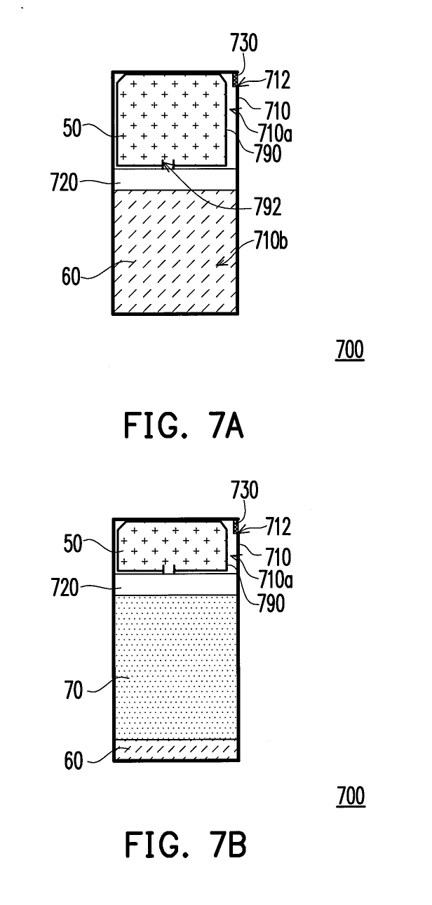

FIG. 7A is a diagram of a hydrogen generation device according to another embodiment of the invention. FIG. 7B is a diagram illustrating a reaction of a liquid reactant and a solid fuel in the hydrogen generation device in FIG. 7A. Referring to FIG. 7A, in the hydrogen generation device 700 of the embodiment, the opening 712 of the containing tank 710 is connected with the first containing space 710a, and the liquid impermeable and gas permeable membrane 730 covers the opening 712. Besides, the hydrogen generation device 700 further includes a bag body 790 disposed in the first containing space 710a of the containing tank 710 and is capable of containing the liquid reactant 50. An opening 792 of the bag body 790 is connected to the buffer layer 720.

Through the disposition described above, the liquid reactant 50 moves towards the buffer layer 720 and the second containing space 710b through the opening 792 and reacts with the solid fuel 60 to generate hydrogen. As shown in FIG. 7B, the water solution 70 generated in the reaction between the liquid reactant 50 and the solid fuel 60 presses the bag body 790, so that the liquid reactant 50 in the bag body 790 continuously flows out from the opening 792 and reacts with the solid fuel 60. Hydrogen generated in the reaction between the liquid reactant 50 and the solid fuel 60 is exhausted through the liquid impermeable and gas permeable membrane 730. Because the liquid reactant 50 is encapsulated by the bag body 790, it is not affected by the pressure and will not pass through the liquid impermeable and gas permeable membrane 730. It should be noted that in other embodiments, the liquid reactant 50 contained in the bag body 790 may also be absorbed by a water absorbing structure to form a water-based adhesive, and the water-based adhesive may be pressed by the water solution 70 and flow out through the opening 792.

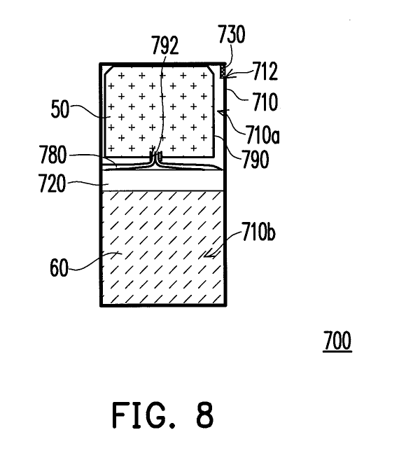

FIG. 8 is a diagram illustrating the disposition of a capillary structure in the hydrogen generation device in FIG. 7A. Referring to FIG. 8, a capillary structure 780 may be further disposed at the opening 792 of the hydrogen generation device 700. The capillary structure 780 may be cotton threads spread on the buffer layer 720, and which absorbs the liquid reactant 50 out of the bag body 790 and conducts it to the buffer layer 720. In other embodiments, a piece of capillary fabric may be disposed on the upper surface of the buffer layer 720 such that the liquid reactant 50 may be evenly distributed in the buffer layer 720. In an embodiment that is not illustrated, the solid fuel 60 is divided into multiple layers, and a filling material (for example, silicon) is disposed between the layers, wherein the quantities of the filling material disposed between these layers may be different, and the quantities of catalyst added to these layers may also be different. In addition, a catalyst or a material which is not reactive (for example, silica micro-particles) may be added to the solid fuel 60 to slow down the reaction, so that hydrogen may be released stably.

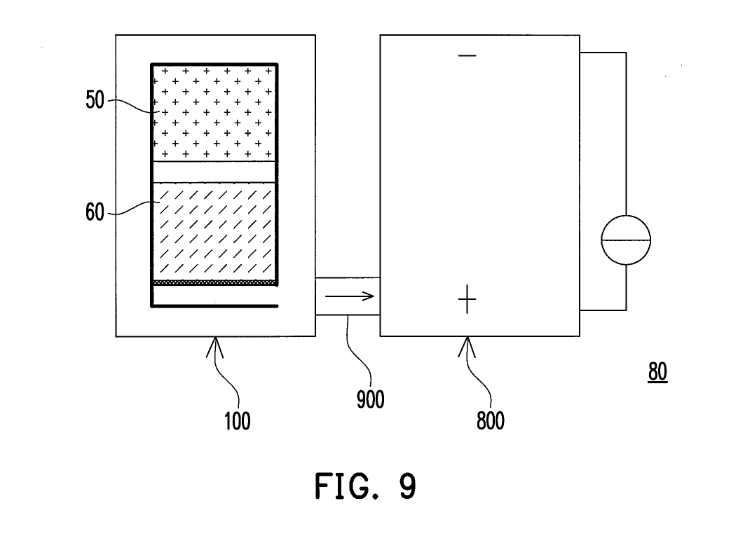

The hydrogen generation devices described in foregoing embodiments may be applied to a fuel cell for supplying hydrogen required by the anode reaction of the fuel cell, which will be described below by taking the hydrogen generation device 100 illustrated in FIG. 1A as an example. FIG. 9 is a diagram illustrating the hydrogen generation device in FIG. 1A being applied in a fuel cell. Referring to FIG. 9, in the present embodiment, the fuel cell 80 includes the hydrogen generation device 100 in FIG. 1A, a fuel cell stack 800, and a guiding structure 900. The guiding structure 900 is connected between the hydrogen generation device 100, and which guides the hydrogen generated in the reaction between the solid fuel 60 and the liquid reactant 50 to the fuel cell stack 800, so that the fuel cell stack 800 may carry out its anode reaction by using the hydrogen. It should be noted that the oxygen required by the cathode reaction of the fuel cell stack 800 may be provided by another supply source, and this part is not illustrated in the present embodiment. The fuel cell 80 in the embodiment may be applied to an electronic device, such as a notebook computer or a cell phone, or a transportation vehicle, such as a car or a boat.

In summary, in an embodiment of the invention, a buffer layer is disposed in a containing tank and is located between a liquid reactant and a solid fuel. The liquid reactant is constantly conducted to the solid fuel through the buffer layer so that the solid fuel slowly reacts with the liquid reactant and accordingly releases hydrogen stably. Since no filling material is added to the solid fuel, the weight percent of hydrogen generated in the reaction is increased, and both the volume and cost of the entire structure are reduced. Moreover, microporous layers may be stacked on the buffer layer to further slow down the reaction between the liquid reactant and the solid fuel. Furthermore, the pressure in the first containing space for containing the liquid reactant may be increased by disposing a piston or triggering a reaction in the first containing space, so that the liquid reactant is pressed downwards and reacts with the solid fuel in the second containing space to generate hydrogen.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A hydrogen generation device, adapted to a fuel cell, the hydrogen generation device comprising:
a containing tank; and
a buffer layer, disposed in the containing tank, for dividing the containing tank into a first containing space and a second containing space, wherein the first containing space is capable of containing a liquid reactant, the second containing space is capable of containing a first solid fuel, and the liquid reactant is capable of entering the second containing space through the buffer layer and reacting with the first solid fuel to generate hydrogen.

2. The hydrogen generation device according to claim 1, wherein the buffer layer comprises:
a filling material; and
a second solid fuel, wherein a part of the liquid reactant is capable of reacting with the second solid fuel to generate hydrogen, so as to turn the buffer layer into a porous structure layer.

3. The hydrogen generation device according to claim 2, wherein the filling material comprises silicon.

4. The hydrogen generation device according to claim 1, wherein the buffer layer comprises a porous structure layer.

5. The hydrogen generation device according to claim 4, wherein the buffer layer further comprises a third solid fuel, and the third solid fuel is filled in pores of the porous structure layer.

6. The hydrogen generation device according to claim 1, wherein the buffer layer is a liquid permeable and gas impermeable membrane.

7. The hydrogen generation device according to claim 1 further comprising a piston, wherein the piston is movably disposed at the first containing space and is capable of moving in the first containing space to change a pressure in the first containing space.

8. The hydrogen generation device according to claim 1 further comprising:
a capsule, disposed in the first containing space, wherein the third solid fuel is capable of being contained in the capsule; and
a resistor, connected to the capsule, when the resistor is heated to burn the capsule, the third solid fuel enters the first containing space and reacts with the liquid reactant to generate a gas, so that the pressure in the first containing space is increased.

9. The hydrogen generation device according to claim 1 further comprising a microporous layer, wherein the microporous layer is stacked on the buffer layer and located in the first containing space or the second containing space.

10. The hydrogen generation device according to claim 1, wherein the containing tank has an opening, the opening is connected with the first containing space or the second containing space, the hydrogen generation device further comprises a liquid impermeable and gas permeable membrane, and the liquid impermeable and gas permeable membrane covers the opening.

11. The hydrogen generation device according to claim 1 further comprising a water absorbing structure, wherein the water absorbing structure is disposed in the first containing space and is capable of absorbing the liquid reactant.

12. The hydrogen generation device according to claim 1 further comprising a bag body, wherein the bag body is disposed in the first containing space and is capable of containing the liquid reactant, and the bag body has an opening connected to the buffer layer.

13. The hydrogen generation device according to claim 12 further comprising a capillary structure, wherein the capillary structure is disposed at the opening and is in contact with the buffer layer.

14. A fuel cell, comprising:
a hydrogen generation device, comprising:
a containing tank;
a buffer layer, disposed in the containing tank, for dividing the containing tank into a first containing space and a second containing space, wherein the first containing space is capable of containing a liquid reactant, the second containing space is capable of containing a first solid fuel, and the liquid reactant is capable of entering the second containing space through the buffer layer and reacting with the first solid fuel to generate hydrogen;
a fuel cell stack; and
a guiding structure, connected between the hydrogen generation device and the fuel cell stack, capable of guiding the hydrogen generated in a reaction between the first solid fuel and the liquid reactant to the fuel cell stack.

15. The fuel cell according to claim 14, wherein the buffer layer comprises:
a filling material; and
a second solid fuel, wherein a part of the liquid reactant is capable of reacting with the second solid fuel to generate hydrogen, so as to turn the buffer layer into a porous structure layer.

16. The fuel cell according to claim 15, wherein the filling material comprises silicon.

17. The fuel cell according to claim 14, wherein the buffer layer comprises a porous structure layer.

18. The fuel cell according to claim 17, wherein the buffer layer further comprises a third solid fuel, and the third solid fuel is filled in pores of the porous structure layer.

19. The fuel cell according to claim 14, wherein the buffer layer is a liquid permeable and gas impermeable membrane.

20. The fuel cell according to claim 14, wherein the hydrogen generation device further comprises a piston, the piston is movably disposed at the first containing space and is capable of moving in the first containing space to change a pressure in the first containing space.

21. The fuel cell according to claim 14, wherein the hydrogen generation device further comprises:
a capsule, disposed in the first containing space, wherein the third solid fuel is capable of being contained in the capsule; and
a resistor, connected to the capsule, wherein when the resistor is heated to burn the capsule, the third solid fuel enters the first containing space and reacts with the liquid reactant to generate a gas, so that the pressure in the first containing space is increased.

22. The fuel cell according to claim 14 further comprising a microporous layer, wherein the microporous layer is stacked on the buffer layer and located in the first containing space or the second containing space.

23. The fuel cell according to claim 14, wherein the containing tank has an opening, the opening is connected with the second containing space, the hydrogen generation device further comprises a liquid impermeable and gas permeable membrane, and the liquid impermeable and gas permeable membrane covers the opening.

24. The fuel cell according to claim 14, wherein the hydrogen generation device further comprises a water absorbing structure, and the water absorbing structure is disposed in the first containing space and is capable of absorbing the liquid reactant.

25. The fuel cell according to claim 14, wherein the hydrogen generation device further comprises a bag body, the bag body is disposed in the first containing space and is capable of containing the liquid reactant, and the bag body has an opening connected to the buffer layer.

26. The fuel cell according to claim 25, wherein the hydrogen generation device further comprises a capillary structure and the capillary structure is disposed at the opening and is in contact with the buffer layer.
